(19) United States
(12) Patent Application Publication
(10) Pub. No.: US 2010/0265557 A1
(43) Pub. Date: Oct. 21, 2010

(54) Optical Systems Configured to Generate More Closely Spaced Light Beams and Pattern Generators Including the Same

(76) Inventor: Jesper SALLANDER, Stockholm (SE)

Correspondence Address: HARNESS, DICKEY & PIERCE, P.L.C., P.O. BOX 8910, RESTON, VA, 20195, US

(21) Appl. No.: 12/764,695

(22) Filed: Apr. 21, 2010

Related U.S. Application Data
(60) Provisional application No. 61/202,927, filed on Apr. 21, 2009.

(51) Int. Cl. G02F 1/00; F21V 5/04

(52) U.S. Cl. 359/237; 362/235; 362/237

(57) ABSTRACT

An optical arrangement includes a focusing lens and a plurality of light sources. The focusing lens is configured to focus a plurality of light beams to form an array of virtual light sources in an image plane. The plurality of light sources are configured to emit the plurality of light beams such that the light beams cross each other in a plane.

### CROSS-REFERENCE TO RELATED APPLICATION(S)

This non-provisional U.S. patent application claims priority under 35 U.S.C. §119(e) to provisional U.S. patent application No. 61/202,927, filed on Apr. 21, 2009, the entire contents of which are incorporated herein by reference.

### FIELD

Example embodiments relate to optical systems or designs, pattern generators, methods for illuminating an object (e.g., a spatial light modulator (SLM)), and methods for generating patterns. Apparatuses and methods according to example embodiments include a number of relatively closely spaced beams relayed from a multitude of discrete light sources.

### BACKGROUND

With increasing power, laser diodes are gaining interest for purposes of illumination in lithographic applications. At shorter wavelengths suitable for photoresist exposures, the power of single diodes is, however, still relatively low (e.g., less than about 1 Watt). Hence, to achieve sufficient power when using laser diodes (e.g., in the shorter wavelength range of about 350 nm to about 450 nm) it is often necessary to use a plurality of laser diodes as emitters. An example manner in which these laser diodes can be arranged is to use a laser diode bar in which a relatively large number of emitters are arranged on the same substrate.

Diode bars are quite common in the infrared wavelength region. Currently, however, the availability of diode bars at shorter wavelengths (e.g., about 400 nm) is limited. This is partly due to the need for relatively high production yield, which is presently not met for the conventional technology at these wavelengths (e.g., Gallium Nitride (GaN)). Also, the sensitivity to air exposure of GaN puts relatively stringent demands on the handling and packaging of such devices. Some materials used in the infrared wavelength region are much less sensitive and the diode bars may be sold naked for original equipment manufacturer (OEM) packaging.

Commercially available blue laser diodes typically come packaged in TO-cans of about 5.6 mm or about 3.8 mm diameter. When assembling tens or hundreds of such laser diodes the resultant structure inevitably becomes a physically large unit. At the same time, it is of interest to keep the points of light emission close to each other in order to achieve a manageable optical solution. One way of keeping the emission points relatively close is to use the above-mentioned diode bars. But, the limitations mentioned above are somewhat preventative.

Another way to keep emission points relatively close is to use optical fibres. The light from each individual laser diode is coupled into an optical fibre and the fibres are bundled into a suitable shape to form the illumination light source. In the case of multi-mode fibres, it is also possible to couple more than one laser diode into one fibre. This makes for a more flexible solution with freedom in the placement of the actual diodes because the diodes are decoupled from the optical path through the optical fibres. The packing density in the fibre bundle may also be relatively high depending on fibre core to cladding ratio.

One potential disadvantage of fibres is the losses that occur when coupling light in and out of the fibres. For multi-mode fibres, the losses are typically of the order of about 20 to 30%. For single-mode fibres and laser diodes, the losses may be as high as about 50% for practical implementations.

### SUMMARY

Example embodiments relate to optical systems or designs, pattern generators, methods for illuminating an object (e.g., an array of light modulating elements, such as a spatial light modulator (SLM), etc.), and methods for generating patterns.

Apparatuses, systems and methods according to example embodiments include a number of relatively closely spaced beams relayed from a multitude of discrete light sources.

Example embodiments describe optical systems and designs including a number of light sources configured such that light beams originating from the light sources cross each other in a same plane. The light beams are further focused by a focusing lens to form an array of virtual light sources in the image plane. The image plane may coincide with a back focal plane of the focusing lens.

Optical arrangements according to at least some example embodiments provide telecentric imaging in the virtual source plane providing parallel light beams, which may create sufficient illumination of an array of modulating elements such as a spatial light modulator (SLM). The array virtual light sources may also be two-dimensional, which may be suitable for a two-dimensional modulating element because this arrangement enables a better homogenization of illumination in a second direction.

Example embodiments of optical systems allow illumination with a relatively closely spaced array of light beams relayed from a multitude of discrete light sources. The configuration provides a packing density of light beams that is higher than or comparable to a packing density achievable through the use of conventional laser diode bars or arrayed optical fibres.

Example embodiments are capable of reducing power losses and increasing lifetimes compared to the conventional art for single-mode applications, multi-mode applications, or combinations thereof.

The “array of virtual light sources” or “virtual light array bar” of relatively densely packed light beams provided by example embodiments may be beneficial for averaging coherence effects caused by single-mode and/or multi-mode light sources when illuminating an array of modulating elements (e.g., a one-dimensional or two-dimensional Spatial Light Modulator (SLM)).

The discrete light sources (e.g., laser diodes) may be arranged in a “fan-like” configuration where the individual light sources may be more easily and selectively replaced without replacing the entire array of actual light sources. Thus, uptime and/or lifetime for the illumination system may be improved.

### BRIEF DESCRIPTION OF THE DRAWINGS

Example embodiments will be described in more detail with regard to the drawings in which:

FIG. 1 illustrates an optical arrangement according to an example embodiment;

FIG. 2 illustrates an optical arrangement according to another example embodiment; and

FIG. 3 illustrates an optical arrangement according to yet another example embodiment.

### DETAILED DESCRIPTION

Example embodiments will now be described more fully with reference to the accompanying drawings, in which some example embodiments are shown. Like reference numerals in the drawings denote like elements. In the drawings, the thicknesses of layers and regions are exaggerated for clarity.

Detailed illustrative embodiments are disclosed herein. However, specific structural and functional details disclosed herein are merely representative for purposes of describing example embodiments. Example embodiments may, however, may be embodied in many alternate forms and should not be construed as limited to only the example embodiments set forth herein.

It should be understood, however, that there is no intent to limit example embodiments to the particular example embodiments disclosed, but on the contrary example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Example embodiments relate to tools for reading and writing patterns and/or images on a workpiece, such as a substrate or wafer. Example embodiments also relate to tools for measuring workpieces. Example substrates or wafers include flat panel displays, printed circuit boards (PCBs), substrates or workpieces for packaging applications, photovoltaic panels, photo-masks, and the like.

According to example embodiments, reading and writing (or patterning) are to be understood in a broad sense. For example, reading operations may include microscopy, inspection, metrology, spectroscopy, interferometry, scatterometry, etc. of a relatively small or relatively large workpiece. Writing (or patterning) may include exposing a photoresist, annealing by optical heating, ablating, creating any other change to the surface by an optical beam, etc.

As discussed herein, the term “lens” may refer to a single lens as well as a lens system including more than one lens element.

Optical systems according to example embodiments may be implemented in (or in conjunction with) pattern generators (or other tools) for writing an image on a workpiece, for example, a pattern generator including one or a plurality of image-generating modulators (also referred to as an array of modulating elements), such as a spatial light modulator (SLM).

Optical systems according to example embodiments may be implemented in (or in conjunction with) measurement and/or inspection tools for measuring a workpiece. A measurement and/or inspection tool, in which one or more example embodiments may be implemented, may include one or a plurality of detectors, sensors (e.g., time delay and integration (TDI) sensors), cameras (e.g., charged coupled devices (CCDs)), or the like.

Example embodiments may also be implemented in pattern generators for writing patterns on a relatively thick substrate such as a three-dimensional (3D) substrate or may be implemented in a tool for measuring or inspecting a relatively thick workpiece or substrate (e.g., a tool for measuring or inspecting a three-dimensional (3D) pattern in a photoresist thicker than between about 2 μm and about 100 μm or more).

Example embodiments may also be implemented in a scanning multi-beam system such as an acousto-optic multi-beam system comprising at least one deflector.

Still further, example embodiments may be implemented in a relatively high throughput optical processing device including one or more rotating optical arms having optics that relay image information from a modulator to the surface of the workpiece while maintaining an essentially consistent orientation relationship between information on the workpiece and information at the hub of the rotating optical arm, even as the arm sweeps an arc across the workpiece.

Example embodiments may also be implemented in a measurement and/or inspection tool including one or more rotating arms comprising one or a plurality of detector sensors.

In a conventional laser diode bar, laser diodes a packed relatively densely on the same wafer or substrate. Typically, the laser diodes are spaced a few hundred micrometers (μm) apart and aligned relatively well. However, it is relatively difficult (or even impossible) to selectively replace one or a portion of dysfunctional laser diode(s) among the relatively large number of densely packed laser diodes without replacing the entire laser diode bar. As a result, when a certain number of emitters no longer function, the entire laser diode bar must be replaced. The emitters cannot be selectively replaced.

Because the lifetime of a laser diode has a statistical distribution, the lifetime of a conventional laser diode bar is most likely shorter (e.g., significantly shorter) than the average lifetime of individual emitters. If too many diodes in the bar no longer function, the local efficiency of the illumination system suffers causing a decrease in the overall performance of the illumination system. Thus, the lifetime of such a conventional laser diode bar may be determined by the shortest lifespan among the individual laser diodes. Consequently, the fact that the laser diodes are on the same wafer or substrate impacts the uptime and production yield of a pattern generator configured to create patterns on a workpiece by using a conventional laser diode bar as the illumination system for illuminating light modulating elements.

A conventional laser diode bar has the potential of providing transverse single-mode beams. And, a fibre array may also be single-mode, but at the expense of light throughput.

Optical system, designs, apparatuses and methods according to at least some example embodiments provide improved lifespan of light source bars and provide relatively densely packed light beams, while conserving beam quality properties of the light sources.

An illumination system having a virtual array of relatively closely spaced light beams relayed from an array of discretely packed light sources (e.g., laser diodes) may resolve the above-identified issues and provide more efficient use of the light emitted from the available light sources.

Example embodiments of the invention describe optical systems and designs including a number of light sources configured such that light beams originating from the light sources cross each other in a same plane. The light beams are further focused by a focusing lens to form an array of virtual light sources in the image plane. The image plane may coincide with a back focal plane of the focusing lens.

Optical arrangements according to at least some example embodiments provide telecentric imaging in the virtual source plane providing parallel light beams, which may create sufficient illumination of an array of modulating elements such as a spatial light modulator (SLM). The array virtual light sources may also be two-dimensional, which may be suitable for a two-dimensional modulating element because this arrangement enables a better homogenization of illumination in a second direction.

At least some example embodiments provide optical systems or designs including a number of light sources configured such that light beams emitted from the light sources are collimated and cross each other in one plane (e.g., the front focal plane of the focusing lens). The light beams are then focused by a focusing lens to form an array of virtual light sources in the image plane. The crossing of the beams in the front focal plane of the focusing lens provides telecentric imaging of the light sources, which enables the virtual light sources to resemble a diode bar or fibre array illumination.

The design of optical systems according to at least some example embodiments allows illumination with a relatively closely spaced array of light beams relayed from a multitude of discrete light sources (e.g., laser diodes). The configuration enables a packing density of the laser beams that is greater than, equal to, similar or substantially similar to the packing density achievable through the use of conventional laser diode bars or arrayed optical fibres, while reducing power losses and increasing lifetimes for single-mode applications, multi-mode applications, or combinations thereof.

Optical systems according to example embodiments provide a virtual array of light sources (e.g., “virtual laser diode bar”), which may be beneficial for averaging coherence effects caused by the single-mode and/or multi-mode light sources when illuminating an array of modulating elements (e.g., a one-dimensional or two-dimensional spatial light modulator (SLM)). The discrete light sources, (e.g., laser diodes) may be arranged in a “fan-like” configuration where the individual diodes are capable of being replaced more easily without replacing the entire array of light sources.

At least one example embodiment provides an optical arrangement including a focusing lens and a plurality of light sources. The focusing lens is configured to focus a plurality of light beams to form an array of virtual light sources in an image plane. The plurality of light sources are configured to emit the plurality of light beams such that the light beams cross each other in a same plane. The image plane may correspond to the back focal plane of the focusing lens.

At least one other example embodiment provides a pattern generating apparatus including an optical arrangement and an array of light modulating elements. The optical arrangement includes a focusing lens and a plurality of light sources. The focusing lens is configured to focus a plurality of light beams to form an array of virtual light sources in an image plane. The plurality of light sources are configured to emit the plurality of light beams such that the light beams cross each other in a same plane. The image plane may correspond to the back focal plane of the focusing lens. The array of modulating elements is configured to be illuminated by the plurality of light beams corresponding to the array of virtual light sources in the image plane. The plurality of light beams corresponding to the array of virtual light sources are reflected or diffracted by the array of modulating elements onto a workpiece to generate a pattern on the workpiece.

At least one other example embodiments provides an optical arrangement comprising a plurality of light sources arranged in a fan-like arrangement, each of the plurality of light sources being configured to generate a light beam and at least one collimator lens being configured to collimate the light beams generated by the plurality of light sources, one of the collimated or non-collimated light beams crossing one another in a same plane and a focusing lens configured to focus the plurality of collimated light beams to form an array of virtual light sources in an image plane.

According to at least one other embodiment, the array of light modulating elements is configured to be illuminated by a plurality of light beams corresponding to the array of virtual light sources in the image plane where the plurality of light beams corresponding to the array of virtual light sources are reflected or diffracted by the array of light modulating elements onto a workpiece to generate a pattern on the workpiece.

At least one other example embodiment provides a pattern generating apparatus including an optical arrangement, a spatial light modulator (SLM) and an optical subsystem. The optical arrangement includes a focusing lens and a plurality of light sources. The focusing lens is configured to focus a plurality of light beams to form an array of virtual light sources in an image plane. The plurality of light sources are configured to emit the plurality of light beams such that the light beams cross each other in a same plane. The image plane may correspond to the back focal plane of the focusing lens. The spatial light modulator (SLM) may be configured to be illuminated by a plurality of light beams corresponding to the array of virtual light sources in the image plane.

The optical subsystem may be configured to direct the light beams corresponding to the array of virtual light sources onto the SLM. The light beams corresponding to the array of virtual light sources may be reflected by the SLM onto a workpiece to generate a pattern on the workpiece.

At least one other example embodiment provides an optical arrangement including a plurality of light sources, a plurality of collimator lenses and a focusing lens.

The plurality of light sources may be arranged in a fan-like arrangement where each of the plurality of light sources is configured to generate a light beam. Each of the plurality of collimator lenses corresponds to one of the plurality of light sources, and is configured to collimate the light beam generated by the corresponding one of the plurality of light sources such that the collimated light beams cross one another in a same plane. The focusing lens is configured to focus the plurality of collimated light beams to form an array of virtual light sources in an image plane.

At least one other example embodiment provides a pattern generating apparatus including an optical arrangement and an array of modulating elements.

The optical arrangement may include a plurality of light sources, a plurality of collimator lenses and a focusing lens. The plurality of light sources may be arranged in a fan-like arrangement and each of the plurality of light sources is configured to generate a light beam. Each of the plurality of collimator lenses corresponds to one of the plurality of light sources, and is configured to collimate the light beam generated by the corresponding one of the plurality of light sources such that the collimated light beams cross one another in one plane. The focusing lens is configured to focus the plurality of collimated light beams to form an array of virtual light sources in an image plane.

The array of modulating elements is configured to be illuminated by the light beams corresponding to the array of virtual light sources. The light beams corresponding to the array of virtual light sources are reflected or diffracted by the array of modulating elements onto a workpiece to generate a pattern on the workpiece.

At least one other example embodiment provides a pattern generating apparatus including an optical arrangement, a SLM and an optical subsystem.

The optical arrangement may include a plurality of light sources, a plurality of collimator lenses and a focusing lens. The plurality of light sources may be arranged in a fan-like arrangement and each of the plurality of light sources is configured to generate a light beam. Each of the plurality of collimator lenses corresponds to one of the plurality of light sources, and is configured to collimate the light beam generated by the corresponding one of the plurality of light sources such that the collimated light beams cross one another in a same plane. The focusing lens is configured to focus the plurality of collimated light beams to form an array of virtual light sources in an image plane.

The SLM is configured to be illuminated by the light beams corresponding to the array of the virtual light sources in the image plane. The optical subsystem may be configured to direct the light beams from the array of virtual light sources onto the SLM. The light beams corresponding to the array of virtual light sources are reflected by the SLM and may further relayed and directed onto a workpiece to generate a pattern on the workpiece.

At least one other example embodiment provides a pattern generating apparatus including an optical arrangement and an array of light modulating elements. The array of light modulating elements may be configured to be illuminated by a plurality of light beams corresponding to the array of virtual light sources. The plurality of light beams corresponding to the array of virtual light sources are reflected or diffracted by the array of light modulating elements and are further relayed and/or directed onto a workpiece to generate a pattern on the workpiece.

At least one other example embodiment provides an optical arrangement including a plurality of light sources arranged in a fan-like arrangement, at least one collimator lens and focusing lens. Each of the plurality of light sources is configured to generate a light beam. The at least one collimator lens is configured to collimate the light beams generated by at least two of the plurality of light sources, wherein the at least two of the collimated or non-collimated light beams cross one another in a same plane. The focusing lens is configured to focus the plurality of collimated light beams to form an array of virtual light sources in an image plane.

At least one other example embodiment provides a pattern generating apparatus including an optical arrangement, and an array of light modulating elements configured to be illuminated by a plurality of light beams corresponding to an array of virtual light sources in the image plane. The plurality of light beams corresponding to the array of virtual light sources are reflected or diffracted by the array of light modulating elements and may further be relayed or directed onto a workpiece to generate a pattern on the workpiece.

At least one other example embodiment provides a pattern generating apparatus including an optical arrangement, a first reflector configured to reflect light beams corresponding to the array of virtual light sources laser beam in a direction orthogonal to a path of the light beams and a second reflector configured to redirect the reflected beams toward a workpiece to pattern the workpiece. At least one of the optical system and the first reflector are configured to produce rotating light sources.

According to at least some example embodiments, the array of light modulating elements is one of a spatial light modulator and a grating light valve.

According to at least some example embodiments, the pattern generating apparatus further includes an optical subsystem configured to direct the plurality of light beams corresponding to the array of virtual light sources onto the array of light modulating elements. The plurality of light beams corresponding to the array of virtual light sources are reflected by the array of light modulating elements onto a workpiece to generate a pattern on the workpiece.

According to at least some example embodiments, the array of virtual light sources may resemble a laser diode bar. The plurality of light sources may be one of single-mode and multi-mode laser sources.

According to at least some example embodiments, the optical arrangement may further include a collimator lens corresponding to each of the plurality of light sources. Each collimator lens may be configured to collimate light output by the corresponding one of the plurality of light sources. Each collimator lens may be arranged at the same radial distance from a crossing point of the plurality of light beams. Alternatively, at least two of the collimator lenses may be arranged at different radial distances from a crossing point of the plurality of light beams.

According to at least some example embodiments, the plurality of light sources may be arranged at the same radial distance from a crossing point of the plurality of light beams. Alternatively, at least two of the plurality of light sources are arranged at different radial distances from a crossing point of the plurality of light beams. For example, every other light source may be arranged at a greater radial distance from the crossing point of the plurality of light beams.

According to at least some example embodiments, the fan-like configuration includes the plurality of laser sources arranged in a substantially semi-circular arrangement.

According to at least some example embodiments, the optical arrangement may further include a single collimating lens positioned at a crossing point of the light beams emitted from the plurality of light sources. The single collimating lens may be configured to collimate the plurality of light beams. The single collimating lens may be positioned at a front focal plane of the focusing lens.

According to at least some example embodiments, the optical arrangement may further include a single collimating lens configured to collimate the plurality of light beams and direct the plurality of light beams toward the focusing lens. The single collimating lens may be positioned at a first distance from the focusing lens along the optical axis of the optical arrangement. The first distance may be equal or substantially equal to a sum of the front focal length of the focusing lens and the back focal length of the collimating lens.

According to at least some example embodiments, the array of virtual light sources is a two-dimensional array.

According to at least some example embodiments, the array of light modulating elements may be one of a spatial light modulator and a grating light valve. The optical subsystem may focus the light beams on the short axis rather than the elongated axis of the SLM.

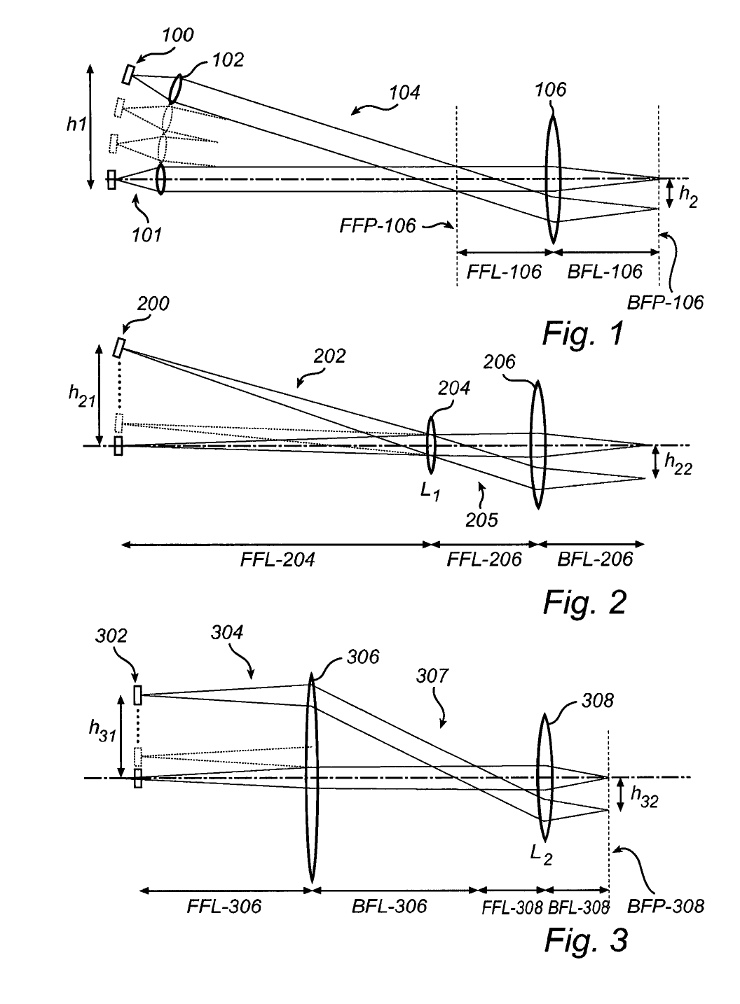

FIG. 1 illustrates an optical arrangement according to an example embodiment. The arrangement shown in FIG. 1 creates a virtual array of densely packed light sources. The arrangement may also be referred to as an optical system.

Referring to FIG. 1, the optical arrangement includes a plurality of light sources 100 arranged in a “fan-like” configuration. More specifically, the light sources 100 are positioned in a semi-circular or substantially semi-circular shape such that each of the light sources 100 is positioned at the same or substantially the same radial distance from a crossing point of the collimated beams 104. The light sources 100 may be spaced apart by few millimeters or a few hundred millimeters.

The crossing point coincides with a front focal plane FFP-106 of a focusing lens 106, and lies on the optical axis of the optical system. In one example, the crossing point may be the point at which the front focal plane FFP-106 and the optical axis intersect.

Still referring to FIG. 1, the optical arrangement further includes a plurality of collimating lenses 102. Each collimating lens 102 is positioned between a corresponding light source 100 and the focusing lens 106 in the path of the light beams 101 emitted from each of the plurality of light sources 100. Each of the collimating lenses 102 is also positioned at the same radial distance from the crossing point such that collimated beams 104 from the collimating lenses 102 cross each other in the same plane (e.g., at the front focal plane FFP-106 of the focusing lens 106, which is at a front focal length FFL-106). As is known, a front focal plane is a plane that is perpendicular to the optical axis at a front focal length (or distance) from a lens.

The collimated beams 104 output from the collimating lenses 102 are focused by the focusing lens 106 to form an array of virtual light sources in the image plane. In this example, the image plane coincides with the back focal plane BFP-106 of the focusing lens 106. The back focal plane BFP-106 is at a distance corresponding to a back focal length BFL-106 of the focusing lens 106. The virtual light source coinciding with the optical axis and the lower virtual light source are spaced apart by a distance h2. As is also known, the back focal plane is a plane that is perpendicular to the optical axis at a back focal distance from a lens. In this example, the front focal length FFL-106 and the BFL-106 are the same or substantially the same.

The example embodiment shown in FIG. 1 may be a symmetric arrangement around the optical axis in which the total source height is 2*h1 and the total virtual source height is 2*h2.

The image plane of the optical system shown in FIG. 1 resembles, through telecentric imaging, an arrangement in which a laser diode bar is arranged in the image plane. The mode structure of the light sources 100 is preserved without the light loss introduced by single-mode fibres. Thus, by utilizing example embodiments, applications requiring relatively high beam quality may take advantage of the single-mode properties of the light sources. Divergence and packing density may be controlled by appropriately choosing focal lengths of the collimation and focusing lenses.

In an alternative example embodiment, the laser diodes (light sources) and collimation lenses are not all positioned at essentially the same radial distance from the crossing point. For example, an arrangement in which some of the diodes (e.g., every second diode and lens) are shifted backwards may increase the packing density of the actual light sources.

In another alternative example embodiment, the beam paths may be folded with mirrors when the light sources are not arranged to coincide with the same plane. This may further increase the packing density of the incoming beams. Such a configuration may, by itself, provide beam spacing smaller than what is possible when placing the diode modules side-by-side, but is still limited by the physical size of the folding mirrors. It may be useful to reduce the physical extension of the light sources, especially when the number of light sources is relatively large. In certain embodiments, the light source system (laser diode system) may be built on one or a plurality of modules (e.g., 1, 5, 10, 27 or more), where each module contains a plurality of sub-modules (e.g., 2, 5, 7 or more), with a light source (laser diode) and, optionally, a collimation lens. Each sub-module may be configured so that each light source (laser diode) after reflection in a mirror has the same distance to the crossing point.

FIG. 2 illustrates an optical system according to another example embodiment.

Referring to FIG. 2, the optical system includes a plurality of light sources 200 positioned to coincide with a front focal plane of a collimating lens 204 at a front focal length FFL-204 from the collimating lens 204. The upper virtual light source and the light source coinciding with the optical axis of the optical system are spaced apart by a distance h21.

A collimating lens 204 is positioned at the crossing point of the beams 202 emitted from the light sources 200. More specifically, the collimating lens 204 is positioned to coincide with a front focal plane of a focusing lens 206. The front focal plane 204 lies at a distance corresponding to the front focal length FFL-206 from the focusing lens 206. The collimating lens 204 is configured to collimate the beams 202 output from the plurality of light sources 200.

The collimated beams 205 output from the collimating lens 204 are focused by the focusing lens 206 to form an array of virtual light sources in an image plane. The image plane coincides with the back focal plane of the focusing lens 206 at back focal length BFL-206 from the focusing lens 206.

In FIG. 2, the crossing point coincides with the front focal plane of the focusing lens 206, and lies on the optical axis of the optical system 20. In one example, the crossing point may be the point at which the front focal plane and the optical axis intersect.

In this example embodiment, the virtual light source that coincides with the optical axis of the optical system and the lower virtual light source are spaced apart by a distance h22. In this example, the front focal length FFL-206 and the back focal length BFL-206 are the same or substantially the same. Moreover, the distance h21 is greater than the distance h22.

The example embodiment shown in FIG. 2 may be a symmetric arrangement around the optical axis in which the total source height is 2*h21 and the total virtual source height is 2*h22.

The optical system shown in FIG. 2 may be suitable for light sources with a lower divergence. An example is a vertical-cavity surface-emitting laser (VCSEL) diode. In some cases it may be possible to replace the collimating lens 204 with an aperture stop such that the collimating lens 204 may be omitted.

According to at least one other example embodiment, the collimating lens 204 may be omitted such that the beams 202 are not collimated prior to reaching the focusing lens 206. Because this optical system functions in the same or substantially the same manner as the optical system shown in FIG. 2, a detailed description is omitted.

In FIGS. 1 and 2, the heights h1 and h21 are given by the source size, which is about 10 millimeters with TO-can diode lasers and realistic lenses. Thus, with between about 20 and 100 sources, inclusive, h1 and/or h21 may be between about 100 and 500 mm. The corresponding values of h2 and h22 may be in the range a few millimeters to a few centimeters.

FIG. 3 illustrates an optical system according to another example embodiment. In the example embodiment shown in FIG. 3, both incoming and outgoing light beams are parallel (e.g., double sided telecentric imaging).

Referring to FIG. 3, the optical system includes a plurality of light sources 302 positioned to coincide with a front focal plane of a collimating lens 306 at a front focal length FFL-306 from the collimating lens 306. The light sources 302 are positioned relatively close to one another. In the example shown in FIG. 3, the upper light source and the light source that coincides with the optical axis of the optical system are separated by a distance h31.

The collimating lens 306 is separated from the focusing lens by a distance D given by Equation (1) shown below.

D=BFL-306+FFL-306 (1)

In Equation (1), BFL-306 refers to the back focal length of the collimating lens 306, and FFL-308 refers to the front focal length of the focusing lens 308.

In FIG. 3, the collimating lens 306 is configured and positioned such that the beams 304 emitted by the light sources 302 are collimated and relayed toward the focusing lens 308. The collimating lens 306 collimates and relays the beams 304 such that the collimated beams 307 cross each other at a same plane, which coincides with the front focal plane of the focusing lens 308 at a front focal length FFL-308. In one example, the crossing point may be the point at which the front focal plane and the optical axis intersect.

Still referring to FIG. 3, the focusing lens 308 focuses the collimated beams 306 to form an array of virtual light sources in the image plane. The image plane coincides with the back focal plane of focusing lens 308 at a back focal length BFL-308 from the focusing lens 308.

The virtual light source coinciding with the optical axis of the optical system in FIG. 3 and the lower virtual light source are spaced apart by a distance h32.

As shown in FIG. 3, the distance h31 is greater than the distance h32 such that the virtual light sources are more closely packed together than the actual light sources 302.

The example embodiment shown in FIG. 3 may be a symmetric arrangement around the optical axis in which the total source height is 2*h31 and the total virtual source height is 2*h32.

Moreover, in FIG. 3 h31 is limited by the lens size and may typically be less than about 150 mm. Distance h32 may be similar to one of h2 and h22 described above.

The example embodiment shown in FIG. 3 may be useful in cases where it is more practical to arrange the light sources parallel to each other. The number of light sources in this example may be limited by the dimension(s) of the collimating lens 306.

The light losses of optical design configurations according to example embodiments are limited to losses in the glass to air surfaces of the lenses. In FIGS. 1-3, the light sources may be laser sources such as diode lasers. But, example embodiments may include any suitable light source such as light emitting diodes (LEDs), VCSEL diodes, etc. In at least some example embodiments where the beams from the light sources are already collimated, the collimating lenses 102 shown in FIG. 1 may be omitted.

The configuration of the optical system according to example embodiments should not be limited to the optical arrangements illustrated in FIGS. 1-3 and may comprise various optical components and elements such as, for example, one or several spherical and/or cylindrical lenses and refractive, reflective or diffractive optical elements, including, but not limited to, for example, one or several mirrors, mirror arrays and gratings.

Optical systems according to example embodiments may be used for illuminating a one-dimensional or two-dimensional array of light modulating elements in a pattern generating apparatus for creating patterns on a mask or for maskless direct writing on a workpiece (e.g., on a substrate or wafer). For example, the one-dimensional array of light modulating elements may be a reflective or diffractive spatial light modulator (SLM) with micro-mirrors as the light modulating elements or a grating light valve (GLV) with ribbons as the light modulating elements.

The one-dimensional SLM may be designed to have one or more (e.g., 2-4, 5-20 or less than 50) active modulating elements in a first short axis direction and more than 200, several thousands, tens of thousands, or even hundreds of thousands of modulating elements in the other elongated axis direction. By illuminating the one-dimensional SLM with the illumination system according to example embodiments, a pattern having a one-dimensional address grid may be created on a workpiece (e.g., a wafer or a substrate).

A two-dimensional SLM may be designed to have hundreds, thousands or tens of thousands of modulating elements in both axis directions in order to create a two-dimensional pattern (address grid) on a workpiece.

Multi-mode laser diodes, which have higher power capabilities, may be used for illuminating a one-dimensional SLM while maintaining single-mode-like properties of the multi-mode diodes in one spatial direction. Combining light from a number of multi-mode diodes may improve statistical averaging and/or reduce the effects of interference and/or speckle in the elongated axis direction (e.g., reduce the coherence effects in the elongated axis direction).

The near-field power distribution of multi-mode diodes is often non-uniform and typically changes with age and usage of the diode resulting in unacceptable non-uniformity in the image to be patterned on the workpiece.

According to at least some example embodiments, the above-described image plane may be a plane relatively close to the back focal plane of the focusing lens. But, this positioning would likely mean a departure from an ideal telecentric imaging. In another alternative example, an SLM or an image thereof may be placed out of focus. In this example, the image of the light sources would still be in the back focal plane of the focusing lens and fully telecentric.

A pattern generator may include the optical arrangement according to example embodiments. The pattern generator may illuminate a workpiece using light emitted by light sources and an optical system as illustrated in FIGS. 1-3.

The light beams emitted from the light sources may be reflected toward an array of light modulating elements by a beamsplitter positioned immediately above another second optical system (e.g., an optical projection system). The array of light modulating elements may receive pattern data indicative of a pattern to be generated on the workpiece. The pattern generator may further include a hardware and software data handling system (not shown) for the array of light modulating elements. Data handling systems are well-known in the art, and thus, a detailed discussion will be omitted.

The array of light modulating elements may reflect light toward the other second optical system and the modulated and reflected light may then be relayed to a workpiece on a fine positioning substrate stage.

According to at least some example embodiments, the array of light modulating elements may be a spatial light modulator (SLM), a grating light valve (GLV) or the like.

A pattern generator according to at least some example embodiments may further include an optical subsystem configured to direct the light beams corresponding to the virtual array of light sources onto the array of modulating elements. In one example, the light beams may be substantially focused on the short axis, but less focused on the elongated axis of the array of modulating elements. This illumination system may also include homogenizing elements such as lens arrays and/or diffractive optical elements (DOE). This may, however, not be necessary. The position of the array of light modulating elements may be such that the overlap of the light corresponding to the virtual array of light sources is enough to provide a homogenous illumination, which simplifies or substantially simplifies the optical system. One advantage with having the light corresponding to the virtual array of light sources overlap in the image plane (e.g., the plane of the array of modulating elements) is that a number of different light sources (e.g., laser diodes) contribute to the total angular spread for a certain modulating element (e.g., mirror) in the array of modulating elements as there will (most likely) be a certain periodicity in the discrete angular contents that the modulating elements (e.g., mirrors) experience.

According to certain example embodiments related to failing light sources (laser diodes) or light sources (laser sources) out of specification, the power of some of the other light sources (laser diodes) may be changed to restore the coherence function to be more similar to the intended one. To avoid problems with landing angle, the distribution of power is made symmetrical by lowering the power of the light source (laser diode) symmetrical to the failed one on the other side of the optical axis. Doing this improves landing angle, but may amplify other image errors such as the large-small balance. Light sources (laser diodes) relatively close to the light sources (laser diodes) with relatively low power are adjusted to a higher power.

The adjustment of the power to the laser diodes may be done automatically by calculation of the coherence function or even the properties of the image and finding (e.g., by iteration) laser diode currents that reduce and/or minimize the resulting errors.

Another possibility is to specify momenta of different orders for the light intensity and bringing the momenta within bounds by modifying the drive currents to the laser diodes. In some cases it may not be possible to recreate the desired momenta, coherence functions, or image properties at the same or substantially the same total power. In those cases, a lower power may be set and the writing speed of the laser writer reduced, in order to keep the laser writer running until a repair can be done.

Likewise, it may be possible to run some laser diodes beyond their safe power levels in order to keep the system running until a repair can take place, thereby eating into the lifetime of the laser diodes slightly, but avoiding unscheduled downtime.

The light sources may be measured constantly or at short, regular intervals using an array of detectors or a camera. The image may be brought to the camera by a beam sampling mirror or grating present in the system. The tuning of the light source currents may be automated in the background and the imaging power of the optical system may be refractive, diffractive or reside in curved mirrors. The reflected image may be illuminated through a beam splitter or at an off-axis angle. The wavelength may be visible (e.g., 405 nm) ultraviolet or extend into the soft x-ray (EUV) range. The light source may be continuous or pulsed: visible, a discharge lamp, one or several laser sources or a plasma source. The object can be a mask in transmission or reflection, or an SLM. The SLM may be binary or analog; for example micromechanical, using LCD modulators, or using electro-optical, magneto-optical, electro-absorptive, electrowetting, acousto-optic, photoplastic or other physical effects to modulate the beam.

Any of the methods described above or aspects of the methods may be embodied in a self correcting illuminator system. The system includes an illuminator having 15 or more illumination elements and optics that combine radiation output from the illumination elements, a power supply coupled to the illumination elements that distributes power to the illumination elements, sensors optically coupled to the radiation output, a controller coupled to the sensors and controlling the power supply, the controller including program instructions that set an initial power level for the illumination elements, wherein initial output levels from the illumination elements produce an overall illumination field from the illuminator that satisfies a quality function. The controller also detects failure of a first illumination element that reduces output from the first element to less than about 20 percent of its initial output level. The controller is further responsive to the detected failure, reduce power distribution to and output from one or more non-failing illumination elements to restore symmetry in the overall illumination field and also responsive to the detected failure, increase power distribution to and output from at least some of the illumination elements to restore quality of the overall illumination field, as measured by the quality function.

One example of the technology disclosed are illumination elements having even spatial distribution. Alternately, the illumination elements may have varying spatial distribution.

Another example of the technology disclosed is expressing said quality function as an approximately Gaussian distribution. Alternately, the quality function may be expressed as an approximately sin(x)/x distribution.

Optical systems according to example embodiments may also be implemented in conjunction with high-speed rotary pattern generators as will be discussed in more detail below.

Rotary pattern generators are high-speed pattern generators including one or more modulators as image-forming devices and/or a high-speed measurement device including one or more detectors or cameras for reading images. Rotary pattern generators according to example embodiments provide improved image quality over a full stamp of the image-forming device, which may be for example, a modulator such as a one-dimensional or two-dimensional spatial light modulator (SLM) or grating light valve (GLV), and over all scan positions.

Rotators according to example embodiments may comprise one or a plurality of arms such as 2, 3, 4, 5, 6 or more arms and each arm may include an optical system for writing or reading a pattern or an image. The reading/writing head of an arm may be stationary or essentially stationary and the optical image is translated by a rotating or swinging optical system from a position near the axis of rotation to a position further away from the axis of rotation.

The rotating optical system may be relatively simple and relatively light, for example, including only two parallel mirrors, and may therefore scan a circle on the workpiece. The rotating optical system may also include one or more lenses (e.g., a final lens for each arm), and/or prisms (e.g., a dove prism). The workpiece is moveable (at least with motion relative to the center of rotation of the optics), for example, continuously or in steps, so that the scanning optics are able to reach all parts of the workpiece. Thus, there may be little or essentially no relative motion between the mirror(s) or optical system (e.g., final lens) positioned at the end of the arm and the position for writing/reading the pattern/image on the workpiece/substrate.

According to example embodiments, the control system knows from the actuators driving the motions or from position and/or angle encoders which part of the workpiece is being written to/read from.

For writing, the controller controls the sending of the intended data to be written to the addressed area. For reading, the read image or data is recorded or analyzed with awareness of where the image or data came from. An important property of rotators according to example embodiments is that the optics may be designed not to rotate the image during the rotation of the optics. Therefore, it is possible to create a contiguous pixel map representing the optical image in the controller, either before it is written or after it has been read.

Example embodiments use the fact that circular motion is easier to control than linear motion. Bearings, such as, fluid bearings, accurately define the center of rotation. If the rotating part is made as a wheel with balancing masses around the center of rotation and given a continuous rotational moment, the only energy needed for the scanning is the one needed to compensate for the losses in the bearing. The rotor (e.g., the rotating optics with mechanical support) may be completely passive and all active parts such as motors, cooling, sensors, etc. may be placed in the stationary mechanics.

It may be more advantageous, at least in some cases, to scan in a number of circular arcs rather than a full circle. This may be achieved using a pyramidal mirror. When the mirror is rotated, the beam hits a different part of the mirror surface. A consequence is that the reflected beam is translated with respect to the optical axis

The rotor scanner principle may be extendable to any number of pyramid facets and rotating arms (e.g., 3, 4, 5 or 6). For each facet, a separate lens system is needed.

Illumination systems with a multitude of discrete light sources according to at least some example embodiments may be configured such that light beams from an arbitrary number of laser-like sources correspond to a virtual array of sources with a relatively high packing density and with parallel beams. This array may be one-dimensional or two-dimensional.

In illumination systems according to at least some example embodiments, limitations of a conventional laser diode bar in which the emitter with the shortest lifespan defines the lifetime of the diode bar may be suppressed or eliminated because individual light sources may be selectively replaced relatively easily.

In at least some example embodiments, beam properties of individual light sources are preserved, and thus, single-mode laser sources provide single-mode beams from the virtual array.

Moreover, the relatively large light losses usually introduced by optical fibres may be suppressed or eliminated, for example, when using single-mode laser diodes as the laser sources.

In at least some example embodiments, multi-mode laser diodes having higher power capabilities may be used while maintaining single-mode like properties of multi-mode diodes in one spatial direction.

In applications combining light from a number of light sources, using multi-mode lasers may improve the statistical averaging and/or reduce the effects of interference and speckle (e.g., coherence effects).

According to at least some example embodiments, the array may be positioned such that there is no need for further homogenizing of the beams, which may reduce the complexity of the optical system.

The foregoing description of example embodiments has been provided for purposes of illustration and description. It is not intended to be exhaustive or to limiting. Individual elements or features of a particular example embodiment are generally not limited to that particular embodiment, but where applicable, are interchangeable and may be used in a selected example embodiment, even if not specifically shown or described. The same may also be varied in many ways. Such variations are not to be regarded as a departure from example embodiments, and all such modifications are intended to be included within scope.

What is claimed is:

1. An optical arrangement comprising:
a focusing lens configured to focus a plurality of light beams to form an array of virtual light sources in an image plane; and
a plurality of light sources configured to emit the plurality of light beams such that the light beams cross each other in a same plane.

2. The optical arrangement of claim 1, wherein the array of virtual light sources resembles a laser diode bar.

3. The optical arrangement of claim 1, wherein the same plane is a front focal plane of the focusing lens.

4. The optical arrangement of claim 1, wherein the plurality of light sources are one of single-mode and multi-mode laser sources.

5. The optical arrangement of claim 1, wherein the plurality of light sources are arranged in a fan-like configuration.

6. The optical arrangement of claim 5, wherein the plurality of light sources are arranged at a same radial distance from a crossing point of the plurality of light beams.

7. The optical arrangement of claim 5, wherein at least two of the plurality of light sources are arranged at different radial distances from a crossing point of the plurality of light beams.

8. The optical arrangement of claim 7, wherein every other light source is arranged at a greater radial distance from the crossing point of the plurality of light beams.

9. The optical arrangement of claim 5, wherein the fan-like configuration comprises:
the plurality of laser sources arranged in a substantially semi-circular arrangement.

10. The optical arrangement of claim 1, further comprising:
a plurality of collimator lenses, each collimator lens corresponding to a light source among the plurality of light sources, and each collimator lens being configured to collimate light output by the corresponding one of the plurality of light sources.

11. The optical arrangement of claim 10, wherein each collimator lens is arranged at a same radial distance from a crossing point of the plurality of light beams.

12. The optical arrangement of claim 10, wherein at least two of the collimator lenses are arranged at different radial distances from a crossing point of the plurality of light beams.

13. The optical arrangement of claim 1, further comprising:
a collimating lens positioned at a crossing point of the plurality of light beams, the collimating lens being configured to collimate the plurality of light beams.

14. The optical arrangement of claim 13, wherein the collimating lens is positioned at a front focal plane of the focusing lens.

15. The optical arrangement of claim 1, wherein the image plane corresponds to the back focal plane of the focusing lens.

16. The optical arrangement of claim 1, further comprising:
a collimating lens configured to collimate the plurality of light beams and direct the plurality of light beams toward the focusing lens.

17. The optical arrangement of claim 16, wherein the collimating lens is positioned at a first distance from the focusing lens along the optical axis of the optical arrangement, the first distance being equal to a sum of the front focal length of the focusing lens and the back focal length of the collimating lens.

18. The optical arrangement of claim 1, where the array of virtual light sources is a two-dimensional array.

19. A pattern generating apparatus comprising:
the optical arrangement of claim 1; and
an array of light modulating elements configured to be illuminated by a plurality of light beams corresponding to the array of virtual light sources; wherein
the plurality of light beams corresponding to the array of virtual light sources are reflected or diffracted by the array of light modulating elements onto a workpiece to generate a pattern on the workpiece.

20. The pattern generating apparatus of claim 19, wherein the array of light modulating elements is one of a spatial light modulator and a grating light valve.

21. The pattern generating apparatus of claim 19, further comprising:
an optical subsystem configured to direct the plurality of light beams corresponding to the array of virtual light sources onto the array of light modulating elements; wherein
the plurality of light beams corresponding to the array of virtual light sources are reflected by the array of light modulating elements onto a workpiece to generate a pattern on the workpiece.

22. The pattern generating apparatus of claim 21, wherein the array of light modulating elements is a spatial light modulator, and the optical subsystem focuses the light beams on the short axis rather than the elongated axis of the spatial light modulator.

23. A pattern generating apparatus comprising:
the optical arrangement of claim 1; and
a first reflector configured to reflect light beams corresponding to the array of virtual light sources laser beam in a direction orthogonal to a path of the light beams;
a second reflector configured to redirect the reflected beams toward a workpiece to pattern the workpiece; wherein
at least one of the optical system and the first reflector are configured to produce rotating light sources.
